(19) United States
(12) Patent Application Publication
(10) Pub. No.: US 2005/0062557 A1
(43) Pub. Date: Mar. 24, 2005

(54) Laminated ceramic coupler

(76) Inventors: Nam Ig Kang, Suwon (KR); Chul Ho Kim, Suwon (KR); Kyung Beek Oh, Suwon (KR); Hee Kon Lee, Suwon (KR); Young Deg Kim, Suwon (KR); Dong Sub Kim, Suwon (KR)

Correspondence Address: LOWE HAUPTMAN GILMAN & BERNER, LLP, Suite 310, 1700 Diagonal Road, Alexandria, VA, 22314, US

(21) Appl. No.: 10/823,705

(22) Filed: Apr. 14, 2004

(30) Foreign Application Priority Data
Sep. 24, 2003 (KR) 2003-66204

(51) Int. Cl. H01P 5/18

(52) U.S. Cl. 333/116

(57) ABSTRACT

Disclosed is a laminated ceramic coupler with a plurality of ports, formed parallel to the lengthwise direction of transmitting lines, serving as bonding electrodes. The coupler comprises a ceramic block, having a plurality of ceramic sheets, with a first and a second transmitting line formed therein; a first to a fourth grooves, running from the top to the bottom of at least one surface perpendicular to the lengthwise direction of the first and the second transmitting line, with such a depth from the surface as to partially expose both ends of each of the first and the second transmitting line; and a first to a fourth ports having first electrode parts formed respectively on the first to the fourth grooves and connected to the ends of the first and the second transmitting line, and second electrode parts formed on one surface parallel to the lengthwise direction of the first and the second transmitting line, with electrical connection to corresponding first electrode parts.

### 1. FIELD OF THE INVENTION

The present invention relates, in general, to a laminated ceramic coupler for use in the division or sampling of signals and, more particularly, to a laminated ceramic coupler having a plurality of external terminals on the same plane, which can be simply fabricated as well as being advantageous in achieving the recent trend of smallness and higher performance.

### 2. DESCRIPTION OF THE PRIOR ART

As well known in the art, couplers are used to measure, divide and synthesize signal power in radio frequency communication circuits such as mobile communication terminals, transponders, satellite broadcasting systems, etc.

A coupler can be represented by the equivalent circuit diagram of FIG. 1. As seen in the circuit diagram, a coupler comprises four input/output ports T1-T4, a first transmitting line L1 for connecting the two input/output ports T1 and T2, and a second transmitting line for connecting the remaining two input/output ports T3 and T4. Between the first and the second transmitting lines, signals are coupled.

Couplers are usually embodied by forming microstrip lines into the structure of FIG. 1 in waveguides or on PCB, with resort to mechanical and etching processes of high precision. Conventional couplers require high mechanical processability and workability for their being fabricated to a desirable performance, which makes mass production difficult and gives rise to an increase in the production cost and product's size and weight.

In order to solve these problems, there has been suggested a multiplayer structure of ceramic radio frequency couplers, which is advantageous in minimizing the size.

With reference to FIG. 2, there is an exploded perspective view showing a conventional radio frequency coupler. As seen, the coupler has a three-layer structure comprising three sheets 11, 12 and 13. Each sheet is made of an insulating material such as a PCB material or ceramic. On the middle sheet 12, a first and a second transmitting line 14 and 15 are formed through which signal power passes. The first and the second transmitting lines 14 and 15 are made by printing an electrically conducting material in a predetermined pattern. The electrically conducting material is so low in resistance properties, like Ag or Cu, as to maintain high Q values in radio frequencies. Both ends of each of the first and the second transmitting line 14 and 15 are extended to sides of the sheet to communicate with the four input/output ports 16 to 19 formed on the side walls of the laminated sheets 11, 12 and 13. The four input/output ports 16 to 19 are formed by coating an electrically conducting material in a predetermined pattern on the side walls of the laminated sheets 11, 12 and 13.

In order to shield the first and the second transmitting lines 14 and 15 from external electromagnetic signals, sheets comprising ground electrodes may be further positioned above and below the sheet 12 comprising the first and the second transmitting line 14 and 15.

In such a conventional coupler, a signal power inputted into the first port 16 is passed through the second transmitting line 15 into the second port 17. At this time, electromagnetic coupling is caused by the capacitance component generated on the ground electrode and/or the first transmitting line 14 and the R, L, C components present in the transmitting lines. As a result, a coupling is formed between the first transmitting line 14 and the second transmitting line 15 so that one ones-th of the signal power is measured at the third port 18 and/or the fourth port 19 of the second transmitting line 15.

The length of each of the first and the second transmitting line 14 and 15 must be one forth of the wavelength (λ) of the radio frequency signal.

Owing to the structure in which the first and the second transmitting line 14 and 15 are formed on the same plane, the conventional radio frequency coupler suffers from the disadvantage of being increased in device size when being used in radio frequency bands. To avoid this problem, a laminated ceramic coupler was suggested in which the first and the second transmitting line 14 and 15 are formed into a multilayer structure.

However, because, on the side wall perpendicular to the surface on which the internal transmitting lines are formed, signal input/output ports 16 to 19 are provided to electrically communicate with the inner transmitting lines, both the conventional couplers and the laminated ceramic couplers are disadvantageous in that a defective may be caused in the electrical linkage between the board circuit and the lateral ports 16 to 19 upon surface mounting. Additionally, a final heat treatment is carried out before the formation of the outer ports. Further, a polishing finish, a vexatious process, must be done to expose the inner transmitting line patterns communicating with the lateral terminals after laminating, pressurizing and sintering processes.

Furthermore, the ports, after the sintering, are externally formed by a printing or a thru-fill method, so that there is needed a space for forming the outer terminals 23. Additionally, in the future, when products are further decreased in size, it will be very difficult to make the outer terminals large enough for communication while securing such a distance between the outer terminals as to avoid the formation of a short circuit in the conventional couplers. Particularly, the outer ports are not uniform among products because the contours of the outer ports are determined by the surface contours of the device.

In a coupler structure where outer terminals are formed at the side walls perpendicular to the electrode patterns of the inner transmitting lines, the relative position between the inner electrodes and the land pattern of the mount board changes according to the directions of the coupler device upon mounting, which causes a small amount of inductance change. This inductance change deteriorates the characteristics when the coupler is used for matching signal circuits to GHz.

### SUMMARY OF THE INVENTION

With the problems in mind, the present invention has an object of providing a laminated ceramic coupler with a plurality of external ports formed on one plane parallel to transmitting line patterns, which is easy for surface mounting and advantageous in achieving the recent trend of smallness and higher functionalization.

The object of the present invention could be accomplished by a provision of a laminated ceramic coupler, comprising: a ceramic block, comprising a plurality of ceramic sheets, with a first and a second transmitting line formed therein; a first to a fourth grooves, running from a top to a bottom of at least one surface perpendicular to a lengthwise direction of the first and the second transmitting line, with such a depth from the surface as to partially expose both ends of each of the first and the second transmitting line; and a first to a fourth ports having first electrode parts formed respectively on the first to the fourth grooves and connected to the ends of the first and the second transmitting line, and second electrode parts formed on one surface parallel to the lengthwise direction of the first and the second transmitting line, with an electrical connection to corresponding first electrode parts.

In accordance with another aspect of the present invention, the ceramic block comprises: a first ceramic sheet functioning as an upper cover; a second ceramic sheet, positioned below the first ceramic sheet, comprising: a first and a second conducting pattern which are generally parallel to each other and are respectively connected to the first electrode parts of the first and the second port at their respective one end; and two via holes formed at the other ends of the first and the second conducting pattern; a plurality of third ceramic sheets, formed in order below the second ceramic sheet, each comprising: a third and a fourth conducting pattern which are generally parallel to each other and are respectively connected at their respective one end through the via holes of a ceramic sheet immediately above each of the third ceramic sheets to the conducting patterns on the ceramic sheet immediately above each of the third ceramic sheets; and two via holes formed respectively at the other ends of the third and fourth conducting pattern; a fourth ceramic sheet, formed below the third ceramic sheets, comprising: a fifth and a sixth conducting pattern which are generally parallel to each other and are respectively connected at their respective one end through the via holes of a ceramic sheet immediately above the fourth ceramic sheet to the conducting patterns on the ceramic sheet immediately above the fourth ceramic sheet while the other ends being electrically connected respectively to the first electrode parts of the third and the fourth port; and a fifth ceramic sheet, formed below the fourth ceramic sheet, having the second electrode parts of the first to the fourth ports on its bottom surface, the second electrode parts being electrically insulated from each other, thereby, the first, the third and the fifth conducting pattern being electrically connected in series to form the first transmitting line while the second, the fourth and the sixth conducting pattern being electrically connected in series to form the second transmitting line.

In a further aspect of the present invention, the first to the fourth grooves have a shape of a rectangular parallelepiped.

In still another aspect of the present invention, the first to the fourth grooves have a shape of a semicircular cylinder.

In still another aspect of the present invention, the first electrode parts of the first to the fourth ports are fabricated by forming the grooves at predetermined positions in the plurality of ceramic sheets of the ceramic block, filling an electrically conducting material in the grooves, and laminating the plurality of ceramic sheets.

In still another aspect of the present invention, the first to the fourth grooves, and the first electrode parts of the first to the fourth ports are fabricated by laminating the plurality of ceramic sheets to give the ceramic block, mechanically processing the ceramic block at four points on at least one surface perpendicular to the lengthwise direction of the first and the second transmitting line to form the first to the fourth grooves, and filling an electrically conducting material in the first to the fourth grooves.

In yet another aspect of the present invention, each of the first to the sixth conducting patterns is a spiral conducting pattern taking at least one turn.

### BRIEF DESCRIPTION OF THE DRAWINGS

FIG. 1 is an equivalent circuit diagram showing a coupler;

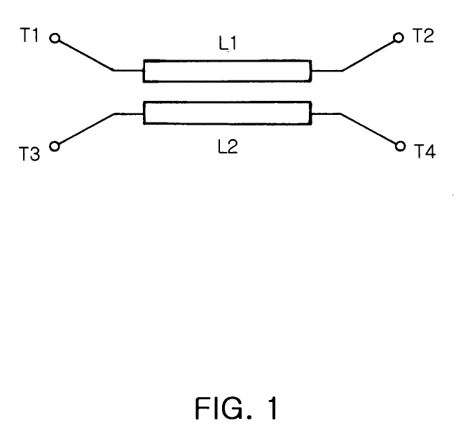

FIG. 2 is an exploded perspective view showing a conventional laminated ceramic coupler;

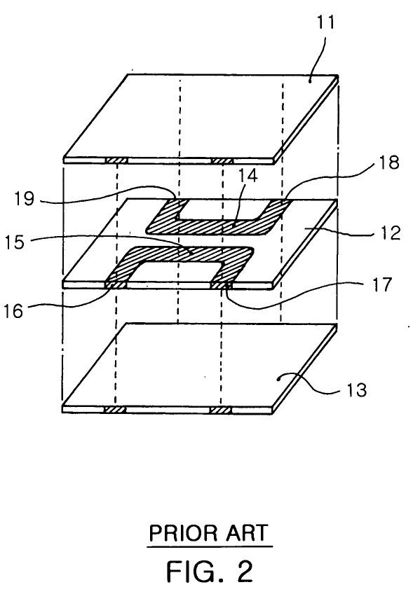

FIG. 3 provides a frontal and a rear perspective view showing a laminated ceramic coupler according to the present invention; and

FIG. 4 is an exploded perspective view showing the laminated ceramic coupler according to the present invention;

### DETAILED DESCRIPTION OF THE INVENTION

The present invention is directed to a laminated ceramic coupler with opposite outer terminals present in one plane, which is advantageous in surface mounting, minimizing the size and higher functionalization.

Below, a description is given of the structure and function of the laminated ceramic coupler of the present invention, with reference to the accompanying drawings.

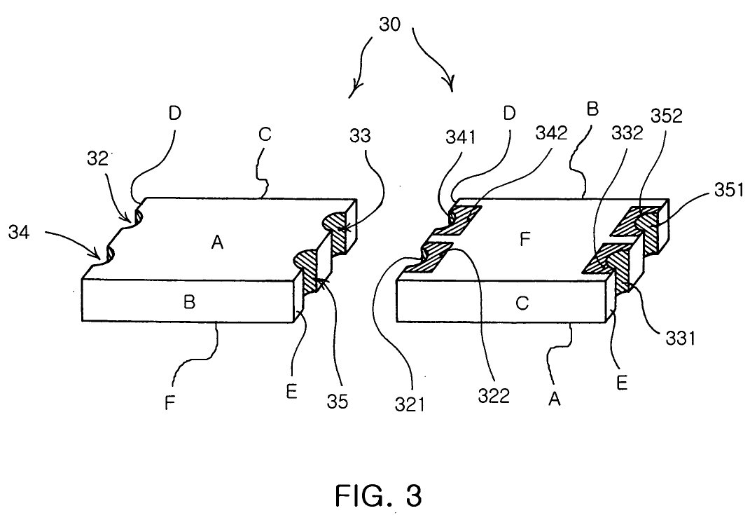

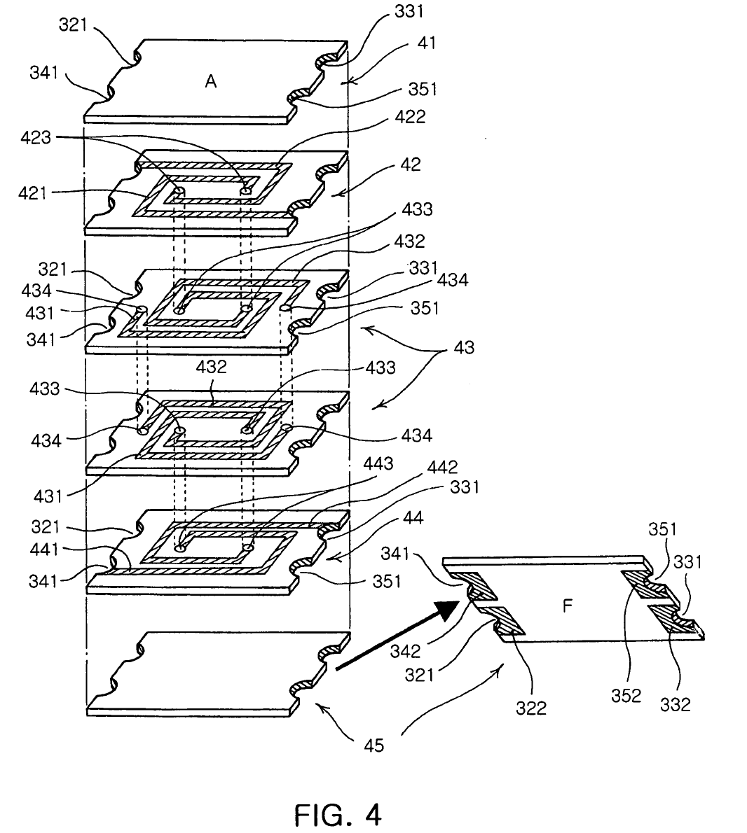

FIG. 3 provides a frontal and a rear perspective view showing a laminated ceramic coupler according to an embodiment of the present invention and FIG. 4 is an exploded perspective view of the coupler.

Referring to FIG. 3, the laminated ceramic coupler of the present invention comprises a ceramic block 30 having an upper covering sheet, a lower covering sheet and a plurality of inner ceramic sheets, with a first and a second transmitting lines of a predetermined length formed therein, each of the inner ceramic sheets having a set of two electrically conducting patterns, the first and second transmitting lines being obtained by connecting a set of the two parallel conducting patterns through via holes to another set of conducting patterns on a neighboring ceramic sheet positioned immediately below and/or above; a first to a fourth grooves 31a to 31d, running from the top to the bottom of at least one surface D, E perpendicular to the lengthwise direction of the laminated conducting patterns, with such a depth from the surface D, E as to partially expose both ends of each of the first and the second transmitting lines; and a first to a fourth ports 33 to 35 having first electrode parts 321, 331, 341 and 351 which are respectively formed on the first to the fourth grooves 31a to 31d and connected to the ends of the first and the second transmitting lines, and second electrode parts 322, 332, 342 and 352 formed to connect to corresponding first electrode parts on one surface parallel to the lengthwise direction of the conducting patterns laminated inside the ceramic block.

Turning to FIG. 4, a structure of the ceramic block 30 of FIG. 4 is shown in detail. As seen in FIG. 4, the ceramic block 30 comprises a plurality of ceramic sheets laminated in order. A first ceramic sheet 41 functions as a cover. Positioned below the first ceramic sheet 41, a second ceramic sheet 42 comprises a first and a second conducting pattern 421 and 422 which are generally parallel to each other and are respectively connected to the first electrode parts 321 and 351 of the first and the second port 32 and 35 at their respective one end while each of the other ends has a via hole 423. A plurality of third ceramic sheets 43 are formed in order below the second ceramic sheet 42. Each of the third ceramic sheets 43 comprises a third and a fourth conducting pattern 431 and 432 which are generally parallel to each other and are respectively connected at their respective one end through the via holes to the conducting patterns on a ceramic sheet immediately above each of the third ceramic sheets 43 while each of the other ends has a via hole 433. A fourth ceramic sheet 44, positioned immediately below the third ceramic sheet 43, comprises a fifth and a sixth conducting pattern 441 and 442 which are generally parallel to each other and are respectively connected at their respective one end through the via holes to the conducting patterns on the ceramic sheet immediately above the fourth ceramic sheet 44 while the other ends are electrically connected respectively to the first electrode parts 341 and 351 of the third and the fourth port 34 and 35. Finally, a fifth ceramic sheet 45 is formed below the fourth ceramic sheet 44 and has the second electrode parts 322 to 352 of the first to the fourth ports 32 to 35 47 on its bottom surface. The second electrode parts are electrically insulated from one another on the bottom surface. In the structure of the coupler according to the present invention, the first, the third and the fifth conducting pattern 421, 431 and 441 are electrically connected in series to form the first transmitting line L1 while the second, the fourth and the sixth conducting pattern 422, 432 and 442 are electrically connected in series to form the second transmitting line L2.

Each of the first to the sixth conducting patterns 421,422 to 441, 442 is formed into a spiral shape taking at least one turn, so that longer transmitting lines can be obtained in a limited design area. As a result, the radio frequency coupler of the present invention can implement desirable performance even with a smaller chip size in comparison to conventional couplers.

The first to the fourth grooves 31a to 31d can be formed by mechanically punching at least one plane perpendicular to the lengthwise direction of the conducting patterns 421, 422 to 441, 442 laminated in the ceramic block 30. In the example illustrated in FIGS. 3 and 4, the grooves are separately provided in the opposite two planes.

The first to the fourth grooves 31a to 31d may take various geometrical configurations, such rectangular parallelepipeds or semicircular cylinders. The grooves 44 and 45 are formed in such a depth from the plane as to expose the end portions of the conducting patterns. A conducting material is coated on the surfaces of the first to the fourth grooves to form the first electrode parts 321 to 351 of the first to fourth ports 32 to 35 which thus electrically communicate with predetermined portions of the inner conducting patterns.

As shown in FIG. 3, the first to the fourth ports 32 to 35 comprise the first electrode parts 321, 331, 341 and 351 formed on the side walls perpendicular to the lengthwise direction of the inner conducting patterns 421, 422, 431, 432, 441 and 442, and second electrode parts 322, 332, 342 and 352, formed on a plane F parallel to the lengthwise direction of the inner conducting patterns 421, 422, 431, 432, 441 and 442, with respective electrical communication with the first electrode parts 321, 331, 341 and 351. The second electrode parts 322, 332, 342 and 352 are used as bonding pads for surface mounting. Thus, the plane F on which the second electrode parts 322, 332, 342 and 352 are formed is positioned below upon surface mounting and called as a lower plane for convenience's sake.

The first to the fourth grooves 31a to 31d, and the first electrode parts 321, 331, 341 and 351 of the first to the fourth ports 32 to 35 can be formed in the following two manners.

First, the ceramic sheets 41 to 45 undergo a mechanical processing to form a geometrical pattern at the same portions, followed by filling a conducting material in the geometrical pattern as well as in the via holes formed in the sheets, at the same time. Laminating the ceramic sheets gives the grooves 31a to 31d with concomitance with the formation of the first electrode parts 321, 331, 341 and 351.

Alternatively, the ceramic sheets 51 to 56 is laminated to give a ceramic block 30 which then undergoes a mechanical processing such as punching at its predetermined side portions to form grooves 31a to 31d running from the top to the bottom of the ceramic block 30. By filling a conducting material in the grooves 31a to 31d, the first electrode parts 321, 331, 341 and 351 of the first to the fourth ports 32 to 35 are produced.

Serving to electrically connect the first and the second transmitting line L1 and L1 present inside the ceramic block 30 to the first to the fourth ports 32 to 35, the first electrode parts 321, 331, 341 and 351 are preferably as small in width as possible if workability is not deteriorated. The reason is that a parasite capacitance is generated in proportion to the electrode area of the outer terminals.

In the structure according to the present invention, the second electrode parts serving as bonding pads are in one plane so that, when the chip is surface mounted, the bonding pads can be positioned parallel to the board. Therefore, the laminated ceramic coupler of the present invention can be always mounted in a definite direction even if no particular marks are used, thereby preventing the property change with mounting directions.

As described hereinbefore, a plularity of port electrodes are formed on one surface parallel to the lengthwise direction of the transmitting lines inside the chip coupler so that the surface mounting of the chip coupler can be easily performed, with a decrease in bonding defects. Additionally, the coupler can be mounted in such a way as to keep constant the distance between the inner transmitting line pattern and the land pattern. The coupler structure according to the present invention allows the transmitting lines to be formed longer in the same size and thus can further minimize the size of radio frequency chip couplers.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A laminated ceramic coupler, comprising:
a ceramic block, comprising a plurality of ceramic sheets, with a first and a second transmitting line formed therein;
a first to a fourth grooves, running from a top to a bottom of at least one surface perpendicular to a lengthwise direction of the first and the second transmitting line, with such a depth from the surface as to partially expose both ends of each of the first and the second transmitting line; and
a first to a fourth ports having first electrode parts formed respectively on the first to the fourth grooves and connected to the ends of the first and the second transmitting line, and second electrode parts formed on one surface parallel to the lengthwise direction of the first and the second transmitting line, with an electrical connection to corresponding first electrode parts.

2. The laminated ceramic coupler as set forth in claim 1, wherein the ceramic block comprises:
a first ceramic sheet functioning as an upper cover;
a second ceramic sheet, positioned below the first ceramic sheet, comprising:
a first and a second conducting pattern which are generally parallel to each other and are respectively connected to the first electrode parts of the first and the second port at their respective one end; and
two via holes formed at the other ends of the first and the second conducting pattern;
a plurality of third ceramic sheets, formed in order below the second ceramic sheet, each comprising:
a third and a fourth conducting pattern which are generally parallel to each other and are respectively connected at their respective one end through the via holes of a ceramic sheet immediately above each of the third ceramic sheets to the conducting patterns on the ceramic sheet immediately above each of the third ceramic sheets; and
two via holes formed respectively at the other ends of the third and fourth conducting pattern;
a fourth ceramic sheet, formed below the third ceramic sheets, comprising:
a fifth and a sixth conducting pattern which are generally parallel to each other and are respectively connected at their respective one end through the via holes of a ceramic sheet immediately above the fourth ceramic sheet to the conducting patterns on the ceramic sheet immediately above the fourth ceramic sheet while the other ends being electrically connected respectively to the first electrode parts of the third and the fourth port; and
a fifth ceramic sheet, formed below the fourth ceramic sheet, having the second electrode parts of the first to the fourth ports on its bottom surface, said second electrode parts being electrically insulated from each other, thereby, the first, the third and the fifth conducting pattern being electrically connected in series to form the first transmitting line while the second, the fourth and the sixth conducting pattern being electrically connected in series to form the second transmitting line.

3. The laminated ceramic coupler as set forth in claim 1, wherein the first to the fourth grooves have a shape of a rectangular parallelepiped.

4. The laminated ceramic coupler as set forth in claim 1, wherein the first to the fourth grooves have a shape of a semicircular cylinder.

5. The laminated ceramic coupler as set forth in claim 1, wherein the first electrode parts of the first to the fourth ports are fabricated by forming the grooves at predetermined positions in the plurality of ceramic sheets of the ceramic block, filling an electrically conducting material in the grooves, and laminating the plurality of ceramic sheets.

6. The laminated ceramic coupler as set forth in claim 1, wherein the first to the fourth grooves, and the first electrode parts of the first to the fourth ports are fabricated by laminating the plurality of ceramic sheets to give the ceramic block, mechanically processing the ceramic block at four points on at least one surface perpendicular to the lengthwise direction of the first and the second transmitting line to form the first to the fourth grooves, and filling an electrically conducting material in the first to the fourth grooves.

7. The laminated ceramic coupler as set forth in claim 2, wherein each of the first to the sixth conducting patterns is a spiral conducting pattern taking at least one turn.
